(19) United States
(12) Patent Application Publication
(10) Pub. No.: US 2016/0160559 A1
(43) Pub. Date: Jun. 9, 2016

(54) PRIVACY SCREEN

(71) Applicant: Activar Construction Products Group, Inc., Minneapolis, MN (US)

(72) Inventors: John Baker, Fort Myers, FL (US); Dianne Rivers, Fort Meyers, FL (US)

(73) Assignee: Activar Construction Products Group, Inc., Minneapolis, MN (US)

(21) Appl. No.: 14/969,121

(22) Filed: Dec. 15, 2015

Related U.S. Application Data
(63) Continuation of application No. 14/504,580, filed on Oct. 2, 2014, now abandoned.
(60) Provisional application No. 61/886,279, filed on Oct. 3, 2013.

(51) Int. Cl. E06B 9/44; E06B 9/60; E06B 9/68

(52) U.S. Cl. CPC E06B 9/44; E06B 9/68; E06B 9/60

(57) ABSTRACT

A window privacy device includes a pair of opposite sides, a header, and a bottom, the pair of opposite sides, the header and the bottom forming a boundary for a window, the window permitting vision through a door or wall, the privacy device including a roller assembly having a privacy screen, the roller assembly being engaged to the header wherein the privacy screen has a first operative drawn vision obstruction position and a second retracted vision non-obstruction position.

### CROSS-REFERENCE TO RELATED APPLICATIONS

This application is a Continuation Application from patent application Ser. No. 14/504,580 entitled Privacy Screen as filed Oct. 2, 2014, the entire disclosure of which is expressly incorporated herein by reference. This application also claims priority to provisional patent application No. 61/886279, filed Oct. 3, 2013, which is expressly incorporated herein by reference.

### BACKGROUND OF THE INVENTION

In the past, privacy and security have been of real and growing concern for occupants of public and commercial buildings, such as schools, hospitals, government institutions and office buildings. Window assemblies, windows, or encased windows as disposed in a door or through a wall provide two-way visibility between rooms, or between a room and a corridor, and may be an important safety feature during normal conditions. However, in certain situations, in which privacy is highly desirable, devices have not been known which completely block or obstruct visibility into the room to enhance security and safety.

In the past, devices have attempted to reduce visibility through a window assembly, window, or an encased window in a door or through a wall, where the devices consisted of one or more horizontal blind assemblies; glazing panels; glazing of glass panes with “electrochromic” properties which utilize an electrical current to keep the glazing transparent; and/or kits which incorporated a hinged door of metal disposed over the glass pane of the window assembly, window, or encased window.

All of the above identified devices are utilized to attempt to reduce visibility through a window assembly, window, or an encased window in a door or through a wall where the devices require the removal of an existing window assembly, window, or an encased window from the door or wall and the instillation of a replacement window assembly, window, or an encased window in the door or wall. The expense of a replacement window kit used to reduce visibility through an existing window assembly, in the past has been particularly problematic, considering such factors as labor and waste, all of which may be economically prohibitive for facilities operating under an established budget.

In the past a number of varying sized window assemblies, windows, or encased windows have been used in a door or through a wall. No device has been known which may be constructed to provide reduced visibility through a window assembly, window, or an encased window, where the device may be easily adapted for use with existing and varying or different sized window assemblies.

In the past a number of different manufactures have constructed non-uniform window assemblies, windows, or encased windows which have been used in a door or through a wall. No device has been known which may be constructed to provide reduced visibility through a window assembly where the device may be easily adapted for use with existing and varying or different manufactures of non-uniform window assemblies.

No device is known which may be quickly and easily retrofitted onto an existing window kit, regardless of size of the window assembly or manufacturer, and which will not adversely impact, breach, or obviate the fire-rating of an existing door and/or window assembly.

### GENERAL DESCRIPTION OF THE INVENTION

In at least one embodiment the combination privacy screen and window assembly and/or the privacy screen assembly consists of a spring-loaded roller assembly and opaque screen which may be quickly lowered into an operative vision obstruction position relative to a window assembly. In some embodiments, when vision obstruction is not required, the opaque screen retracts following the actuation of a button, leaving full visibility through the window assembly. In at least one embodiment the roller assembly is completely enclosed within a housing which may be fabricated by aluminum extrusion, and powder-coated to provide a match to the dark bronze or gray colors used by most manufacturers of window kits.

In some embodiments the privacy screen assembly includes a housing which may be attached to the existing steel or galvanized steel window assembly by means of powerful, internally-mounted magnets or through the use of strips or portions of mating hook and loop fabric material. In some embodiments the privacy screen assembly may be manufactured in any number of desired width and/or length dimensions for the provision of an opaque screen having a width dimension of less or more than 16 inches and a length dimension of more or less than 35 inches. In some embodiments the dimensions selected for the housing for the privacy screen assembly are constructed to match the exterior or interior dimensions for the window assembly. In some embodiments a very close color match to the existing window assembly is provided where the privacy screen assembly will appear to a casual observer as a single product or component.

In at least one embodiment, a privacy screen assembly may be used on a variety of manufacturer's existing window assemblies. In at least one embodiment, the bottom portion of the privacy screen assembly may include an angled surface to allow for a precise match to the existing window assembly glazing opening.

In at least one embodiment, the use of extruded aluminum for the housing of the privacy screen assembly results in an elegant, “rolled-edge” appearance, and facilities the provision of a visual match of the privacy screen with an existing window assembly.

In some embodiments, the fire-rating of the existing door and privacy screen assembly is not compromised, in that in at least one embodiment no screws or other penetrating attachments are used for engagement of the privacy screen to the existing window assembly.

In at least one embodiment, the privacy screen assembly installs in a matter of seconds where it may require more time for an individual to open the shipping box and remove the privacy screen assembly than the time it will require to “install” the privacy screen assembly.

In at least one embodiment, the privacy screen may be easily relocated/moved from one existing window assembly to another, provided that the window assemblies are the same size.

In some embodiments, the privacy screen is far more affordable than other solutions which may require the purchase and installation of a completely new window assembly.

In at least one embodiment, a window privacy device is provided including a privacy screen assembly, the privacy screen assembly having a pair of opposite sides, a header, and a bottom, the pair of opposite sides, the header and the bottom forming a boundary for a window. The privacy screen assembly further includes a roller assembly having a privacy screen, the roller assembly being engaged to the header wherein the privacy screen has a first operative drawn vision obstruction position and a second retracted vision non-obstruction position.

In at least one embodiment, at least one of the pair of opposite sides, the header, and the bottom include an adjustable angle surface.

In some embodiments, each of the pair of opposite sides have a channel constructed and arranged to slidably receive the privacy screen.

In at least one embodiment, the privacy screen includes a resilient member engaged to the privacy screen proximate to a privacy screen bottom edge.

In some embodiments, the window privacy device includes a left glide disposed in one of the channels and a right glide disposed in the other channel, each of the left glide and the right glide being engaged to the resilient member or the privacy screen.

In at least one embodiment, the roller mechanism includes a retraction device and an actuation button.

In some embodiments, the retraction device has a spring, the spring receiving tension upon placement of the privacy screen in said first operative drawn vision obstructing position.

In at least one embodiment, the retraction device is operatively engaged to the actuation button, the actuation button being constructed and arranged to automatically retract the privacy screen from the first operative drawn vision obstructing position to the second retracted vision non-obstructing position.

In some embodiments, a window privacy device includes a window assembly having a left exterior surface, a right exterior surface, an upper exterior surface, and a lower exterior surface, the left exterior surface, the right exterior surface, the upper exterior surface, and the lower exterior surface forming a boundary for a window. In some embodiments, a privacy screen assembly is engaged to the window assembly, the privacy screen assembly including a pair of opposite sides, a header, and a bottom, one of the pair of opposite sides is disposed proximate to the left exterior surface, one of the pair of opposite sides is disposed proximate to the right exterior surface, the header is disposed proximate to the upper exterior surface, and the bottom is disposed proximate to the lower exterior surface.

In at least one embodiment, the privacy screen assembly further includes a roller assembly having a privacy screen, the roller assembly being engaged to the header wherein the privacy screen has a first operative drawn vision obstruction position and a second retracted vision non-obstruction position. In some embodiments, at least one attachment member is disposed between the window assembly and the privacy screen assembly, the attachment member being constructed and arranged to secure the privacy screen assembly to the window assembly.

In some embodiments, at least one of the pair of opposite sides, the header, and the bottom have an adjustable angled surface.

In at least one embodiment, each of the pair of opposite sides has a channel constructed and arranged to slidably receive the privacy screen.

In some embodiments, the privacy screen includes a resilient member engaged to the privacy screen proximate to a privacy screen bottom edge.

In at least one embodiment, a left glide is disposed in one of the channels and a right glide is disposed in the other channel, each of the left glide and the right glide being engaged to the resilient member or the privacy screen.

In some embodiments, the roller mechanism includes a retraction device and an actuation button.

In at least one embodiment, the retraction device includes a spring, the spring receiving tension upon placement of the privacy screen in the first operative drawn vision obstructing position.

In some embodiments, the retraction device is operatively engaged to the actuation button, the actuation button being constructed and arranged to automatically retract the privacy screen from the first operative drawn vision obstructing position to the second retracted vision non-obstructing position.

In at least one embodiment, the attachment member includes hook and loop material.

In at least one embodiment, the attachment member includes at least one magnet.

In at least one embodiment, attachment member does not adversely affect a fire rating for a door or a wall.

### BRIEF DESCRIPTION OF THE DRAWINGS

FIG. 1 is a front elevation view of one embodiment of a combination privacy screen assembly and window assembly.

FIG. 2 is a partial cross-sectional side view of one embodiment of a combination privacy screen assembly and window assembly taken along the line 2-2 of FIG. 1.

FIG. 3 is an isometric environmental view of one embodiment of a combination privacy screen assembly and window assembly.

FIG. 4 is an exploded isometric view of one embodiment of a privacy screen assembly for engagement to an existing window assembly.

FIG. 5 is a top view of one embodiment of a privacy screen assembly.

FIG. 6 is a front elevation view of one embodiment of a privacy screen assembly.

FIG. 7 is a side view of one embodiment of a privacy screen assembly.

FIG. 8 is an exploded environmental view of one embodiment of a privacy screen assembly positioned for placement over a window assembly.

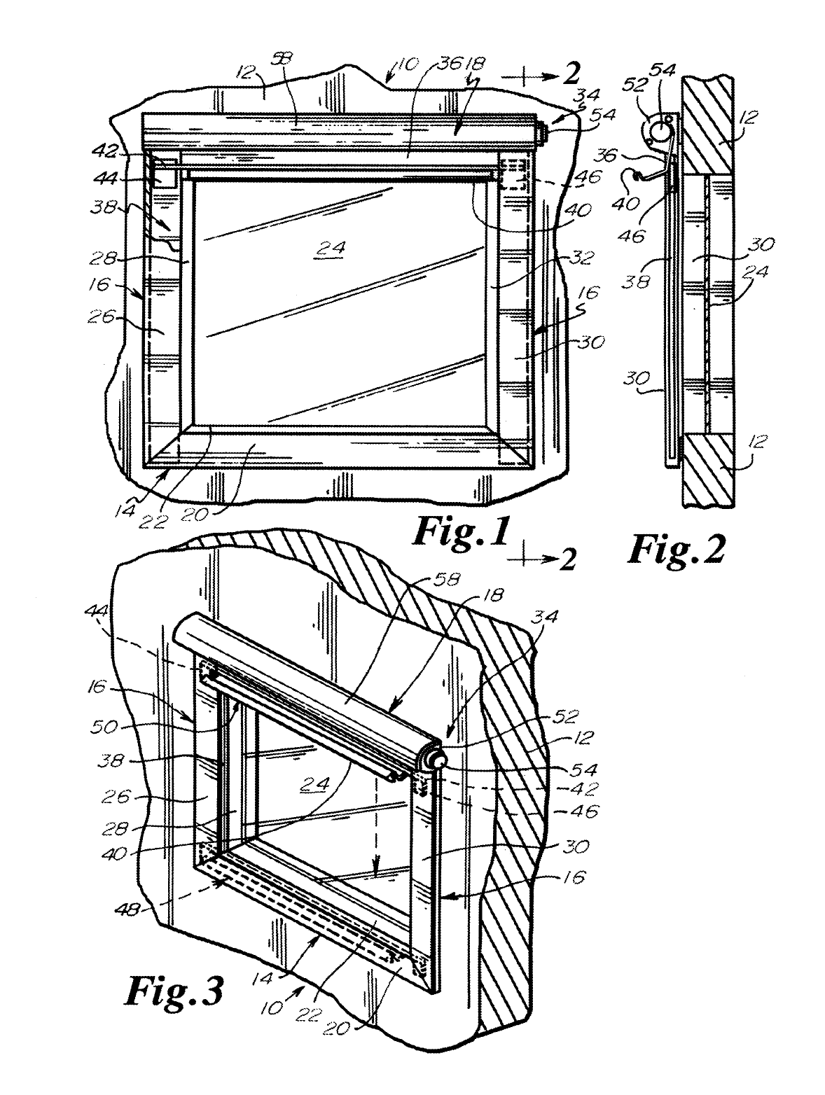

### DETAILED DESCRIPTION OF THE PREFERRED EMBODIMENTS

In at least one embodiment as depicted in FIG. 1 an integral privacy screen and window assembly 10 is shown. The integral privacy screen and window assembly 10 may traverse a door or wall 12 and include a bottom 14, a pair of opposite sides 16, and a top portion or extrusion header 18. In at least one embodiment the bottom 14, pair of opposite sides 16 and top 18 may be formed of extruded aluminum or other suitable metal, plastic, or sturdy composite materials, or combinations thereof. In some embodiments, the bottom 14 may be referred to as an extrusion footer which may include an adjustable angled lower surface 20, which in turn may be disposed proximate to the lower ledge 22 of the integral privacy screen and window assembly 10. In some embodiments, the adjustable angled lower surface 20 is disposed proximate to the lower edge of the window 24. In other embodiments, the lower ledge 22 may be disposed proximate to the lower edge of the window 24.

In some embodiments, the integral privacy screen and window assembly 10 may also include a left adjustable angled surface 26 and/or a left ledge 28 and a right adjustable angled surface 30 and/or a right ledge 32.

In some embodiments the width dimensions for the adjustable angled lower surface 20 between the lower ledge 22 and the bottom 14 may be equal to or greater than 1 inch. In other embodiments, the width dimension for the adjustable angled lower surface 20 between the lower ledge 22 and the bottom 14 may be equal to or less than 1 inch and/or of any dimension as desired. In some embodiments, the width dimensions of the left adjustable angled surface 26 between the ledge 28 and the respective left exterior side 16 may be equal to, greater than, or less than 1 inch and may also be equal to, greater than, or less than the width dimension of the adjustable angled lower surface 20. In some embodiments the width dimension of the right adjustable angled surface 30 between the right ledge 32 and the respective right exterior side 16 may be equal to, greater than, or less than 1 inch and may also be equal to, greater than, or less than the width dimension of the adjustable angled lower surface 20. In some embodiments, the width dimension selected for the right adjustable angled surface 30 and the left angled adjustable surface 20 may be identical so that the integral privacy screen and window assembly 10 will be symmetrical. In some embodiments, the width dimension for the left adjustable angled surface 26, right adjustable angled surface 30 and adjustable angled lower surface 20, will be identical.

In some embodiments, the integral privacy screen and window assembly 10 will include a top ledge and a top adjustable angled surface (not shown).

In some embodiments, as depicted in FIGS. 1 and 3, the integral privacy screen and window assembly 10 includes a roller assembly 34 which in turn may include a privacy screen 36. (FIG. 1)

In at least one alternative embodiment referring to FIGS. 1 and 3, the integral privacy screen and window assembly 10 is shown disposed through a wall 12 shown in cross-section. As may be seen in FIG. 3, in some embodiments, a channel or slot 38 is disposed proximate to the junction between the left adjustable angled surface 26 and the left ledge 28.

An opposite channel or slot 38 may also be disposed proximate to the junction between the right adjustable angled surface 30 and the right ledge 32.

In some embodiments, the privacy screen 36 may include a grasping portion 40. In some embodiments, the grasping portion 40 may be a handle and/or may include a rubber or plastic grasping edge.

In some embodiments, the privacy screen 36 includes a resilient member 42 which is disposed along the bottom edge of the privacy screen 36. In some embodiments the resilient member 42 extends outwardly from the left and right sides of the privacy screen 36, and the resilient member 42 is disposed in the respective right and left channels or slots 38. In some embodiments as depicted in FIGS. 1 and 3 a left handle glide 44 is disposed in the left channel 38 proximate to the left end of the resilient member 42, and a right handle glide 46 is disposed in the right channel 38 proximate to the right end of the resilient member 42. In some embodiments, the left and right channels or slots 38 extend vertically downward from a position proximate to the top portion 18 to a position proximate to the lower ledge 22.

In some embodiments, the left handle glide 44, right handle glide 46, and resilient member 42, are engaged to the privacy screen 36, and in conjunction with the left and right channels or slots 38 function to position the privacy screen 36 a desired distance from the window 24 in either a first operative drawn vision obstructing position 48, or a second retracted vision non-obstructing position 50.

As may be seen in FIG. 3 the grasping portion 40 may include an outwardly angularly disposed portion which may be used to position the grasping portion 40 exterior to the lower ledge 22 when the privacy screen 36 is disposed in the first operative drawn vision obstructing position 48. In some embodiments, the outwardly angularly disposed portion of the grasping portion 40 enables the resilient member 42 to be disposed immediately adjacent to, or in contact with, the lower ledge 22 or of the adjustable angled lower surface 20.

In some embodiments as depicted in FIGS. 1 and 3 the left and right channels or slots 38 may extend downwardly from the top portion 18 to a position below the lower ledge 22. In some embodiments, the left and right channels or slots 38 do not reach the bottom 14 of the integral privacy screen and window assembly 10.

In some embodiments the roller assembly 34 may include a right cap 52 and an actuation button 54 which is used to uncoil a spring 56, or other actuation member or device, to retract the privacy screen 36 from a first operative drawn and vision obstructing position 48 to a second retracted and vision non-obstructing position 50.

In at least one embodiment, the roller assembly 34 and the privacy screen 36 are at least partially covered by a protector 58.

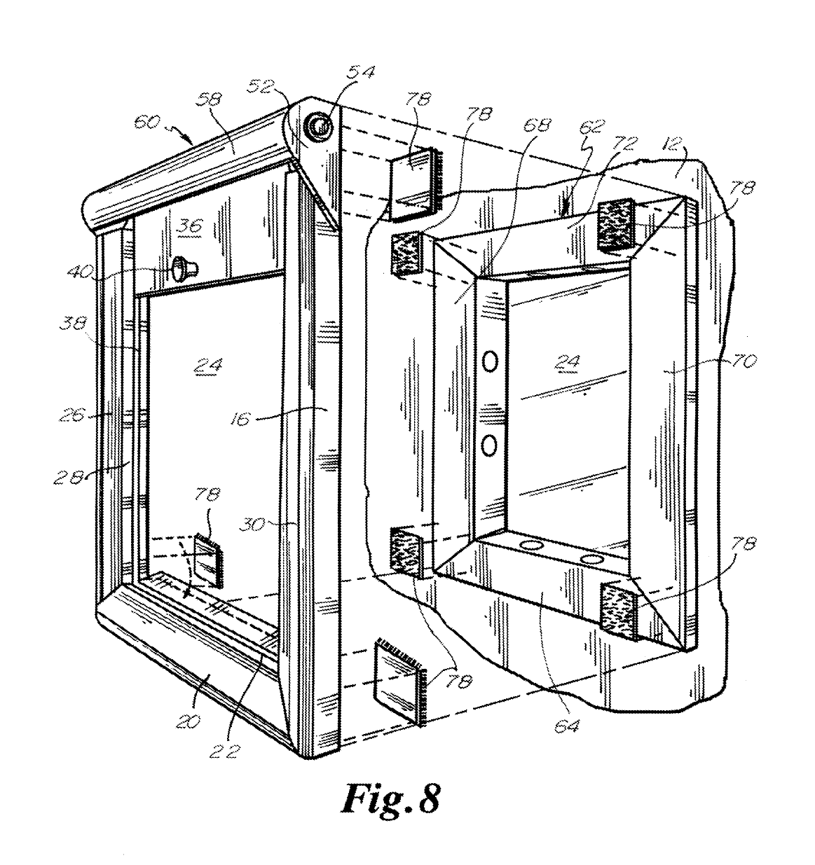

Referring to FIGS. 4 and 6 through 8, in at least one embodiment, a privacy screen assembly 60 may be releasably attached to an existing window assembly 62 which has been previously engaged to a door or wall 12. In at least one embodiment as depicted in FIG. 4, a privacy screen assembly 60 is engaged to an existing window assembly 62 through the use of magnets 66. It should be noted that alternative affixation mechanisms may be used to either permanently or releasably attach a privacy screen assembly 60 to an existing window assembly 62 including the use of magnets 66 (FIG. 4), hook and loop fabric material (FIG. 8), adhesives or other mechanical or chemical attachment mechanisms. It should be noted that in some embodiments the affixation mechanism used to either permanently or releasably secure a privacy screen assembly 60 to an existing window assembly 62 does not adversely affect the fire rating for the existing window assembly 62 and/or door or wall 12.

In at least one embodiment, the materials selected for the left adjustable angled surface 26, left ledge 28, adjustable angled lower surface 20, lower ledge 22, right adjustable angled surface 30, right ledge 32 and/or the top portion 18 are formed of materials, including steel or ferrous materials, or portions of steel or ferrous materials, or combinations thereof which may receive magnets 66 to engage a privacy screen assembly 60 to an existing window assembly 62.

In at least one embodiment as shown in FIG. 4, the privacy screen assembly 60 generally includes a bottom 14, a pair of opposite sides 16, and a top or extrusion header 18. In general, the bottom 14, pair of opposite sides 16 and extrusion header 18 are formed of extruded aluminum, metal, plastic, composite materials and combinations thereof. The bottom 14 may also be referred to as and extrusion footer which may include an adjustable angled lower surface 20 which may be disposed proximate to a lower exterior surface 64 of an existing window assembly 62.

In some embodiments, the interior of each of the opposite sides 16 include a channel or slot 38. The channel or slot 38 in the opposite sides 16 serves the purpose as earlier described with respect to the embodiments described in FIGS. 1 and 3. In addition, in some embodiments a resilient member 42 extends outwardly from the respective left and right edges of the privacy screen 36 proximate to the lower portion or edge. A left handle glide 44 and a right handle glide 46 are engaged to the resilient member 42 and are disposed in the respective left or right channels or slots 38. The features and functions for the privacy screen 36, resilient member 42, left handle glide 44, right handle glide 46, and grasping portion 40 are equally applicable to the embodiments as depicted in FIGS. 4 and 6 through 8.

In at least one embodiment, the privacy screen assembly 60 includes a roller mechanism 34 as earlier described which may be disposed, or partially disposed, in a protector 58 as earlier described.

In some embodiments the back of the left ledge 28, left adjustable angled surface 26, lower ledge 22, lower adjustable angled surface 20, right ledge 32, right adjustable angled surface 30, and top portion 18 may be open and sized to nest or receive the left exterior surface 68, lower exterior surface 64, the right exterior surface 70 and the upper exterior surface 72 respectively of the existing window assembly 62 to position and either releasably or permanently secure the privacy screen assembly 60 onto the existing window assembly 62.

In at least one embodiment of the privacy screen assembly 60 as shown in FIG. 4, the protector 58 includes a left end cap 74. In some embodiments, the left end cap 74 and the right end cap 52 provides support for the roller assembly 34 to rotate about a pin or axle 76. In at least one embodiment, at least a portion of the pin or axle 76 is rotatable relative to the left end cap 74 and right end cap 52.

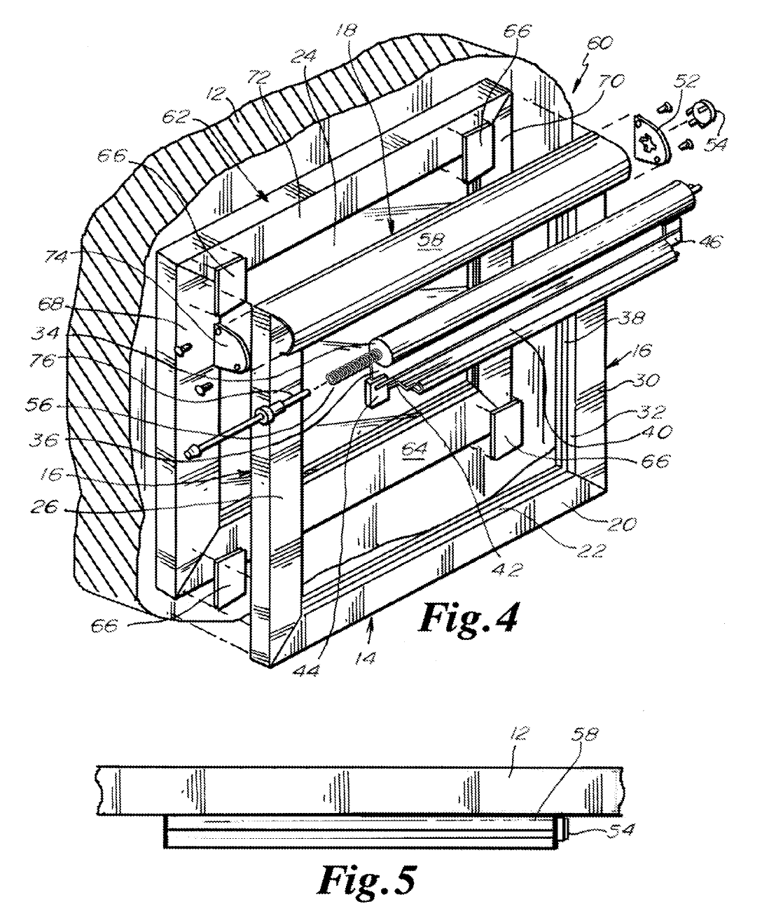

As may be seen in FIG. 5, in at least one embodiment the top of a combination privacy screen and window assembly 10 or a privacy screen assembly 60 is shown.

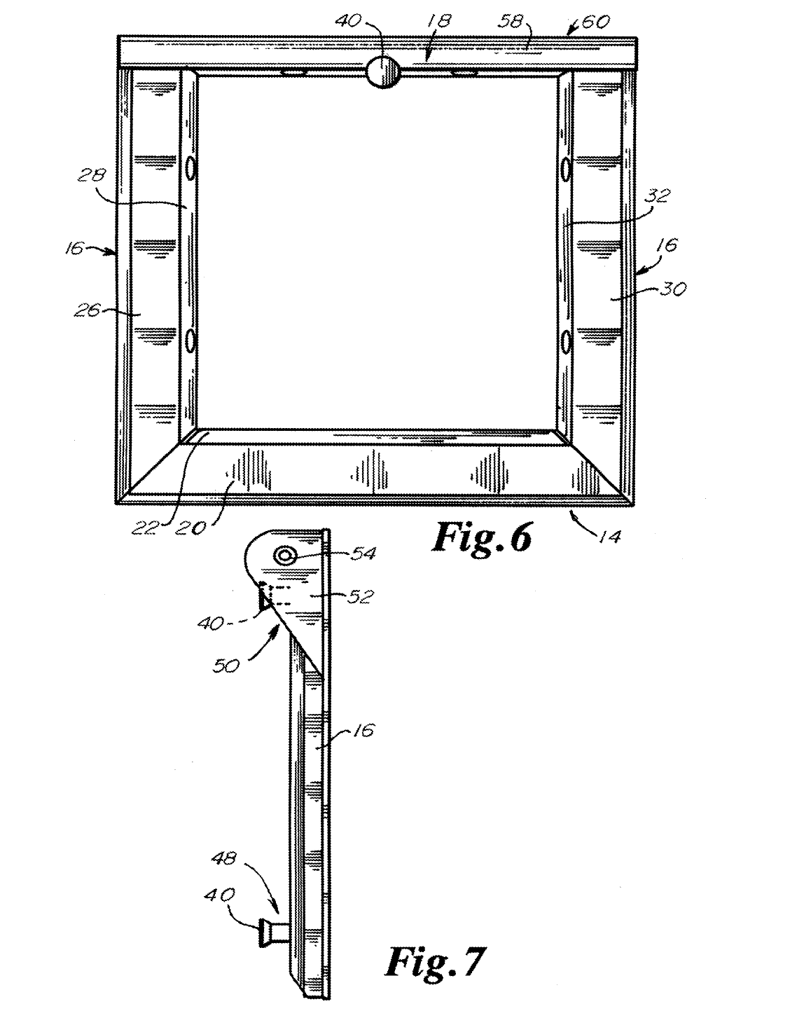

In at least one embodiment as depicted in FIG. 6, the grasping portion 40 of the privacy screen assembly 60 may be a knob or handle. In some embodiments as depicted in FIG. 7 the knob or handle of the grasping portion 40 may be actuated between the first operative drawn vision obstructing position 48 and the second retracted vision non-obstructing position 50.

In at least one embodiment as depicted in FIG. 8, the magnets 66 (FIG. 4) have been replaced with portions of mating hook and loop material 78. In some embodiments, the entire interior circumference, or any desired portion thereof, of the privacy screen assembly 60, may be constructed and arranged for receipt of magnets 66 and/or portions of mating hook and loop material 78, in any desired combination, to secure the privacy screen assembly 60 to a an existing window assembly 62.

In some embodiments, the magnets 66 or the portions of mating hook and loop material 78 may engage the exterior edge of the face, the exterior edge, or the interior edge of the existing window assembly 62 in any combination or at any desired location. In some embodiments any desired number of magnets and/or portions of hook and loop material 78 may be utilized to engage the privacy screen assembly 60 to the existing window assembly 62.

In some embodiments, a plurality of magnets 66 are disposed between a an existing window assembly 62 and a privacy screen assembly 60 where the magnets 66 are constructed and arranged to magnetically engage the left exterior surface 68, the right exterior surface 70, the lower exterior surface 64 and/or the upper exterior surface 72 in any combination to secure the existing window assembly 62 to position the privacy screen 36 in operative engagement to the existing window assembly 62.

In at least one embodiment, the spring loaded roller assembly 34 is positioned to the interior of the extrusion header 18, and is hidden from observation from the front of the combination privacy screen and window assembly 10 or the privacy screen assembly 60. In at least one embodiment, the actuation of the privacy screen 36 and roller assembly 34 into the first operative drawn vision obstructing position 48 loads or coils the spring 56.

In at least one embodiment, in both the combination privacy screen and window assembly 10 or the privacy screen assembly 60, the privacy screen 36 is secured to the roller assembly 34, along an edge opposite to the privacy screen bottom edge. In some embodiments, the roller assembly 34 includes a roller which may be cylindrical in shape where the privacy screen 36 is rolled about the roller.

In some embodiments, the actuation button 54 is operatively engaged to the spring loaded roller assembly 34 which upon actuation will automatically return the privacy screen 36 into a rolled and second retracted vision non-obstructing position 50 within the extrusion header 18, leaving the window 24 of the existing window assembly 62 unobstructed to permit observation therethrough.

In certain embodiments the spring loaded roller assembly 34 includes an almost infinite number of intermediate positioning locations or stops which permit the privacy screen 36 to be operatively disposed in a covering relationship or partial covering relationship at any desired location relative to the existing window assembly 62 or window 24.

Other devices may also be used to lower and raise the privacy screen 36 relative to the roller assembly 34. In certain embodiments the extrusion header 18 may be formed of multiple spring loaded lowering and retraction assemblies to raise or lower the privacy screen 36.

In some embodiments, the privacy screen 36 is completely opaque and in other embodiments the privacy screen 36 is partially opaque. In at least one embodiment, the left and right channels or slots 38 prevent the opaque privacy screen 36 from moving away or separating from the combination privacy screen and window assembly 10, or privacy screen assembly 60, as a result of air movement within a room. Outward separation of the privacy screen 36 towards the interior of a room, away from the window 24 is thereby prohibited. In at least one embodiment, the channels or slots 38 restrict the movement of the opaque privacy screen 36 to vertical movement relative to the bottom 14 and extrusion header 18.

In some embodiments the privacy screen is formed of alternative types of metals, plastics, fabrics, natural, artificial, and/or composite materials, individually or in any combination, provided that the materials and/or elements selected for the privacy screen are of sufficiently durability to function for their intended purpose without failure during normal operating conditions.

The bottom 14, opposite sides 16, and extrusion header 18 may be engaged together into a unitary structure through any common mechanical affixation techniques including fasteners, welding, and/or bending from a single sheet of metal or other material as described herein.

In a first alternative embodiment, a window privacy device includes a privacy screen assembly, the privacy screen assembly comprising: a pair of opposite sides, a header, and a bottom, the pair of opposite sides, the header and the bottom forming a boundary for a window, the window being constructed and arranged to permit vision through a door or wall; the privacy screen assembly further comprising a roller assembly comprising a privacy screen, the roller assembly being engaged to the header wherein said privacy screen has a first operative drawn vision obstruction position and a second retracted vision non-obstruction position.

In a second alternative embodiment according to the first embodiment, at least one of the pair of opposite sides, the header, and the bottom comprise an adjustable angled surface.

In a third alternative embodiment according to the second embodiment, each of the pair of opposite sides comprises a channel constructed and arranged to slidably receive the privacy screen.

In a fourth alternative embodiment according to the third embodiment, the privacy screen comprises a resilient member engaged to the privacy screen proximate to a privacy screen bottom edge.

In a fifth alternative embodiment according to the fourth embodiment, the left glide is disposed in one of the channels and a right glide is disposed in the other channel, each of the left glide and the right glide being engaged to the resilient member or the privacy screen.

In a sixth alternative embodiment according to the fifth embodiment, the roller mechanism comprises a retraction device and an actuation button.

In a seventh alternative embodiment according to the sixth embodiment, the retraction device comprises a spring, the spring receiving tension upon placement of the privacy screen in the first operative drawn vision obstructing position.

In an eighth alternative embodiment according to the seventh embodiment, the retraction device is operatively engaged to the actuation button, the actuation button being constructed and arranged to automatically retract the privacy screen from the first operative drawn vision obstructing position to the second retracted vision non-obstructing position.

In a ninth alternative embodiment, a window privacy device comprises a an existing window assembly comprising a left exterior surface, a right exterior surface, an upper exterior surface, and a lower exterior surface, the left exterior surface, the right exterior surface, the upper exterior surface, and the lower exterior surface forming a boundary for a window, the window being constructed and arranged to permit vision through a door or wall; a privacy screen assembly engaged to the existing window assembly, the privacy screen assembly comprising: a pair of opposite sides, a header, and a bottom, one of the pair of opposite sides being disposed proximate to the left exterior surface, one of the pair of opposite sides being disposed proximate to the right exterior surface, the header being disposed proximate to the upper exterior surface, and the bottom being disposed proximate to the lower exterior surface, the privacy screen assembly further comprising a roller assembly comprising a privacy screen, the roller assembly being engaged to the header wherein the privacy screen has a first operative drawn vision obstruction position and a second retracted vision non-obstruction position; and at least one attachment member disposed between the existing window assembly and the privacy screen assembly, the attachment member being constructed and arranged to secure the privacy screen assembly to the existing window assembly.

In a tenth alternative embodiment according to the ninth embodiment, at least one of the pair of opposite sides, the header, and the bottom comprise an adjustable angled surface.

In an eleventh alternative embodiment according to the tenth embodiment, each of the pair of opposite sides comprises a channel constructed and arranged to slidably receive the privacy screen.

In a twelfth alternative embodiment according to the eleventh embodiment, the privacy screen comprises a resilient member engaged to the privacy screen proximate to a privacy screen bottom edge.

In a thirteenth alternative embodiment according to the twelfth embodiment, the window privacy device further comprises a left glide disposed in one of the channels and a right glide disposed in the other channel, each of the left glide and the right glide being engaged to the resilient member or the privacy screen.

In a fourteenth alternative embodiment according to the thirteenth embodiment, the roller mechanism comprises a retraction device and an actuation button.

In a fifteenth alternative embodiment according to the fourteenth embodiment, the retraction device comprises a spring, the spring receiving tension upon placement of the privacy screen in the first operative drawn vision obstructing position.

In a sixteenth alternative embodiment according to the fifteenth embodiment, the retraction device is operatively engaged to the actuation button, the actuation button being constructed and arranged to automatically retract the privacy screen from the first operative drawn vision obstructing position to the second retracted vision non-obstructing position.

In a seventeenth alternative embodiment according to the sixteenth embodiment, the attachment member comprises hook and loop material.

In an eighteenth alternative embodiment according to the sixteenth embodiment, the attachment member comprises at least one magnet.

In a nineteenth alternative embodiment according to the sixteenth embodiment, the attachment member does not adversely affect a fire rating for the door or the wall.

A vision lite assembly is engaged to and extends through a door. The vision lite assembly is metallic and has a left exterior surface, a right exterior surface, an upper exterior surface, and a lower exterior surface, the left exterior surface, the right exterior surface, the upper exterior surface, the lower exterior surface forming an exterior boundary for the vision lite assembly where the vision lite assembly permits vision through the door.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

1. A window privacy device comprising:
a window assembly comprising;
a metallic frame comprising a left exterior surface, a right exterior surface, an upper exterior surface, and a lower exterior surface, said left exterior surface, said right exterior surface, said upper exterior surface, and said lower exterior surface forming an exterior boundary for said window assembly, said window assembly being disposed in a door, wherein said window assembly permits vision through said door;
a privacy screen assembly comprising;
a unitary metallic frame comprising a left opposite side, a right opposite side, a header, and a bottom, said header comprising a roller assembly comprising a privacy screen, wherein said privacy screen has a first operative drawn vision obstruction position and a second retracted vision non-obstruction position and wherein said left opposite side is disposed proximate to the exterior of said left exterior surface, said right opposite side is disposed proximate to the exterior of said right exterior surface, said header is disposed proximate to the exterior of said upper exterior surface and said bottom is disposed proximate to the exterior of said lower exterior surface in an engaged position with said window assembly; and
at least one releasable engagement member being disposed between and releasably engaged to at least one of said left opposite side and said left exterior surface, said right opposite side and said right exterior surface, said header and said upper exterior surface, and said bottom and said lower exterior surface, wherein said privacy screen assembly is releasably engaged to said exterior boundary of said window assembly covering said metallic frame.

2. The window privacy device according to claim 1, said roller assembly comprising a retraction device comprising a spring, wherein said retraction device automatically retracts said privacy screen from said first operative drawn vision obstructing position to said second retracted vision non-obstructing position.

3. The window privacy device according to claim 2, said left opposite side having a left channel and said right opposite side having a right channel.

4. The window privacy device according to claim 3, said privacy screen comprising a bottom edge comprising a resilient member, said resilient member having a left glide disposed in said left channel and a right glide disposed in said right channel.

5. The window privacy device according to claim 1, said at least one releasable engagement member comprising at least one magnet.

6. The window privacy device according to claim 1, said at least one releasable engagement member comprising at least one mating hook and loop fastening member.

7. The window privacy device according to claim 1, said at least one releasable engagement member comprising at least one magnet and at least one mating hook and loop fastening member.

8. The window privacy device according to claim 1, wherein at least one releasable engagement member is disposed between and releasably engaged to at least two of said left opposite side and said left exterior surface, said right opposite side and said right exterior surface, said header and said upper exterior surface, and said bottom and said lower exterior surface.

9. The window privacy device according to claim 1, wherein at least one releasable engagement member is disposed between and releasably engaged to each of said left opposite side and said left exterior surface, said right opposite side and said right exterior surface, said header and said upper exterior surface, and said bottom and said lower exterior surface.

10. A window privacy device comprising:
a vision lite assembly comprising;
a metallic frame comprising a left exterior surface, a right exterior surface, an upper exterior surface, and a lower exterior surface, said left exterior surface, said right exterior surface, said upper exterior surface, and said lower exterior surface forming an exterior boundary for said vision lite assembly, said vision lite assembly being disposed in a door, wherein said vision lite assembly permits vision through said door;
a privacy screen assembly comprising;
a unitary metallic frame comprising a left opposite side, a right opposite side, a header, and a bottom, said header comprising a roller assembly comprising a privacy screen, wherein said privacy screen has a first operative drawn vision obstruction position and a second retracted vision non-obstruction position and wherein said left opposite side is disposed proximate to the exterior of said left exterior surface, said right opposite side is disposed proximate to the exterior of said right exterior surface, said header is disposed proximate to the exterior of said upper exterior surface and said bottom is disposed proximate to the exterior of said lower exterior surface in an engaged position with vision lite assembly; and
at least one releasable engagement member being disposed between and releasably engaged to at least one of said left opposite side and said left exterior surface, said right opposite side and said right exterior surface, said header and said upper exterior surface, and said bottom and said lower exterior surface, wherein said privacy screen assembly is releasably engaged to said exterior boundary of said vision lite assembly covering said metallic frame.

11. The window privacy device according to claim 10, said roller assembly comprising a retraction device comprising a spring, wherein said retraction device automatically retracts said privacy screen from said first operative drawn vision obstructing position to said second retracted vision non-obstructing position.

12. The window privacy device according to claim 11, said left opposite side having a left channel and said right opposite side having a right channel.

13. The window privacy device according to claim 12, said privacy screen comprising a bottom edge comprising a resilient member, said resilient member having a left glide disposed in said left channel and a right glide disposed in said right channel.

14. The window privacy device according to claim 10, said at least one releasable engagement member comprising at least one magnet.

15. The window privacy device according to claim 10, said at least one releasable engagement member comprising at least one mating hook and loop fastening member.

16. The window privacy device according to claim 10, said at least one releasable engagement member comprising at least one magnet and at least one mating hook and loop fastening member.

17. The window privacy device according to claim 10, wherein said at least one releasable engagement member is disposed between and releasably engaged to at least two of said left opposite side and said left exterior surface, said right opposite side and said right exterior surface, said header and said upper exterior surface, and said bottom and said lower exterior surface.

18. The window privacy device according to claim 10, wherein said at least one releasable engagement member is disposed between and releasably engaged to each of said left opposite side and said left exterior surface, said right opposite side and said right exterior surface, said header and said upper exterior surface, and said bottom and said lower exterior surface.

19. A window privacy device comprising:
a vision lite assembly comprising;
a metallic frame comprising a left exterior surface, a right exterior surface, an upper exterior surface, and a lower exterior surface, said left exterior surface, said right exterior surface, said upper exterior surface, and said lower exterior surface forming an exterior boundary for said vision lite assembly, said vision lite assembly being disposed in a door, wherein said vision lite assembly permits vision through said door;
a privacy screen assembly comprising;
a unitary metallic frame comprising a left opposite side, a right opposite side, a header, and a bottom, said left opposite side having a left channel and said right opposite side having a right channel, said header comprising a roller assembly comprising a privacy screen, wherein said privacy screen has a first operative drawn vision obstruction position and a second retracted vision non-obstruction position, said roller assembly further comprising a retraction device comprising a spring, wherein said retraction device automatically retracts said privacy screen from said first operative drawn vision obstructing position to said second retracted vision non-obstructing position, said privacy screen comprising a bottom edge comprising a resilient member, said resilient member having a left glide disposed in said left channel and a right glide disposed in said right channel, and wherein said left opposite side is disposed proximate to the exterior of said left exterior surface, said right opposite side is disposed proximate to the exterior of said right exterior surface, said header is disposed proximate to the exterior of said upper exterior surface and said bottom is disposed proximate to the exterior of said lower exterior surface in an engaged position with said vision lite assembly; and
at least one releasable engagement member comprising hook and loop material being disposed between and releasably engaged to each of said left opposite side and said left exterior surface, said right opposite side and said right exterior surface, said header and said upper exterior surface, and said bottom and said lower exterior surface, wherein said privacy screen assembly is releasably engaged to said exterior boundary of said vision lite assembly covering said metallic frame.

20. A combination privacy screen assembly and vision lite assembly comprising:
said vision lite comprising;
a metallic frame comprising a left exterior surface, a right exterior surface, an upper exterior surface, and a lower exterior surface, said left exterior surface, said right exterior surface, said upper exterior surface, and said lower exterior surface forming an exterior boundary for said vision lite assembly, said vision lite assembly being disposed in a door, wherein said vision lite assembly permits vision through said door;
said privacy screen assembly comprising;
a unitary metallic frame comprising a left opposite side, a right opposite side, a header, and a bottom, said header comprising a roller assembly comprising a privacy screen, wherein said privacy screen has a first operative drawn vision obstruction position and a second retracted vision non-obstruction position and wherein said left opposite side is disposed proximate to the exterior of said left exterior surface, said right opposite side is disposed proximate to the exterior of said right exterior surface, said header is disposed proximate to the exterior of said upper exterior surface and said bottom is disposed proximate to the exterior of said lower exterior surface in an engaged position with said vision lite assembly; and
at least one releasable engagement member being disposed between and releasably engaged to at least one of said left opposite side and said left exterior surface, said right opposite side and said right exterior surface, said header and said upper exterior surface, and said bottom and said lower exterior surface, wherein said privacy screen assembly is releasably engaged to said exterior boundary of said vision lite assembly covering said metallic frame.
